(19) United States
(12) Patent Application Publication
(10) Pub. No.: US 2011/0315649 A1
(43) Pub. Date: Dec. 29, 2011

(54) Safety Device, Boom with a Safety Device and Construction Machine

(75) Inventor: Heinz Neuffer, Bregenz (AT)

(73) Assignee: LIEBHERR-WERK NENZING GMBH, Nenzing (AT)

(21) Appl. No.: 13/166,636

(22) Filed: Jun. 22, 2011

(30) Foreign Application Priority Data
Jun. 29, 2010 (DE) 10 2010 025 481.9

(51) Int. Cl. B66C 15/00; A62B 35/00; B66C 23/64

(52) U.S. Cl. 212/347; 182/36; 182/3

(57) ABSTRACT

The present disclosure relates to a safety device, in particular for the fall protection of persons during the inspection of a crane boom, with at least one guide directly and/or indirectly arranged on the side of the stepping plane and with at least one guiding means which is movably guidable or guided in a sliding manner in the and/or through the guide, wherein a suspension means is attachable or attached to the guiding means, by means of which at least one protective equipment is suspendable or suspended. Furthermore, the present disclosure relates to a boom with a safety device, and a construction machine.

### CROSS REFERENCE TO RELATED APPLICATION

This application claims priority to German Patent Application No. 10 2010 025 481.9, entitled “Safety Device, Boom with a Safety Device and Construction Machine”, filed Jun. 29, 2010, which is hereby incorporated by reference in its entirety for all purposes.

### TECHNICAL FIELD

The present disclosure relates to a safety device, a boom with a safety device, and a construction machine.

### BACKGROUND AND SUMMARY

Cranes often have large booms. Furthermore, it is frequently necessary to inspect the boom of the crane, for example in order to check the boom or to eliminate possibly existing technical problems by hand. For this purpose, step-on gratings can be provided on the boom, which provide for an inspection of the crane.

For safety reasons it is important to create a possibility for protection against falling from the crane boom during the inspection of the boom.

From DE 10 2009 018 689 A1 there is already known a boom element for a lifting gear such as a crane. At the boom element two unfoldable supporting struts are provided, which in the unfolded condition stretch out a safety rope on which a user can hang in a safety strap for fall protection.

It would be desirable, however, that with a plurality of boom elements coupled to each other re-hanging of the safety strap is not necessary, as such re-hanging at least requires a free hand and therefore limits the working possibilities of the worker or crane operator. Furthermore, the user of such a protection system is unprotected for a moment, unless he uses a second safety strap. However, this is awkward to do. Furthermore, it is disadvantageous that the strap can sag, so that in the case of a fall the fall is not stopped directly, but only at the moment when the safety strap is tightened by the fall.

Therefore, it is the object of the present disclosure to develop a safety device as mentioned above in an advantageous way, in particular to the effect that the same has a safe and simple construction and provides for a protection at any time.

In accordance with the present disclosure, this object is solved by a safety device, for example for the fall protection of persons during the inspection of a crane boom, with at least one guide directly and/or indirectly arranged on the side of the stepping plane and with at least one movable guide which is movably guidable or guided in a sliding manner in the and/or through the guide, wherein a suspension device is attachable or attached to the movable guide, by which at least one protective equipment is suspendable or suspended.

The stepping plane, for example, is that plane along which a user can walk in the erected condition of the device. In a crane boom in the erected condition, for example, this is the upper side of the crane boom on which the user can walk along the crane boom.

The arrangement on the side of the stepping plane provides the advantage that the safety device involves very little impairment of the freedom of movement of the user. The user can move quite freely and at the same time is permanently protected. A protection is possible along the entire length of the guide, without re-hanging e.g. from one protection system to the next or without a renewed protection being required.

For example, it is easily possible to extend the guide substantially along the entire length of a crane boom, so that the entire crane boom can be inspected with one single protecting operation. This protecting operation may be performed at the beginning of the inspection of the boom by hanging in the protective equipment. When the boom consists of a plurality of boom elements, the points of abutment for example between the boom elements can now be bridged without handholds.

The protective equipment for example can be designed as a tight-fitting safety corset or as safety vest. The protective equipment may be designed such that it carries the weight of the user in case of a fall. In this connection it is conceivable to pad points exposed to a great load in case of a fall, in order to reduce the risk of injury for the user.

In addition, it can be provided that the suspension device includes at least one tightening device, by which the protective equipment can be suspended in a tightened manner, and/or that the suspension means includes at least one safety strap which preferably is adjustable in its length. The tightening device provides the advantage that the safety strap always is adjusted to the body size and/or body posture of the user. Such tightening for example can be designed comparable to a belt tensioner in a motor vehicle. In this way, sagging of e.g. a safety strap advantageously can be avoided. The safety strap thus can intervene immediately in case of a fall. The risk of a so-called slack rope does not exist, and instead the fall height always is kept as small as possible. In addition, it is achieved by the tightening means that the user is optimally protected against falling in every working position, since the tightening device also follows any change in the body posture or movement and a tightening in particular of the safety strap is ensured. Thus, the forces occurring in a fall are kept as small as possible, so that the risk of injury can further be reduced for the user.

Furthermore, it is possible that the guide is and/or comprises a rail and/or that two parallel guides are provided, wherein the suspension device is arranged on both guides. In one example, the rails can be made of lightweight material, in particular can constitute aluminum sections or aluminum rails. This involves e.g. the advantage that the crane boom is only loaded with a comparatively very small additional weight.

Advantageously, it is conceivable that the safety device comprises a stepping plane, wherein at least one movable guide is arranged on both long sides of the stepping plane. The stepping plane for example can include a step-on grating.

It is possible that the safety strap is arranged with two articulation points on the at least one guide and with one articulation point on the protective equipment or an element of the protective equipment, so that the safety strap is or can be stretched out between the at least three articulation points in triangular or Y-shaped form.

Furthermore, it can be provided that the protective equipment includes a swivel by means of which a change in the running direction can be performed, in particular without re-hanging the protective equipment, and wherein the swivel is at least part of the articulation point for the safety strap. The swivel advantageously provides for a free choice of the running direction, since the user can rotate without having to re-hang his protective equipment e.g. from a first to a second protection system. The swirl advantageously can rotate relative to the protective equipment.

In addition, the present disclosure relates to a boom for a crane with the safety device. Accordingly it is provided that a boom for a crane is provided with at least one safety device according. Advantageously, a safely inspectable boom for a crane can thereby be created, which offers a protection against falls in a user-friendly manner.

It is advantageous that the protection system can easily be retrofitted on a boom.

It can be provided that the boom includes at least one boom end element and at least one boom center element, which each include at least one rail, wherein in the assembled condition of boom end element and boom center element the rail are connected to form a common guide rail and wherein the boom end element includes a rail end device, by means of which the movable guide can be prevented from leaving the rail means.

With additional limit stops at the guides it is possible to safely move on each individual boom part.

Furthermore, the present disclosure relates to a construction machine. Accordingly, it is provided that a construction machine, in particular a crane, is provided with at least one safety device according and/or with at least one boom having the safety device.

Further details and advantages of the present disclosure will now be explained in detail below with reference to an embodiment illustrated in the drawings, each of which is drawn approximately to scale, which represents an example scale as others may also be used.

### BRIEF DESCRIPTION OF THE FIGURES

FIG. 1 shows a top view of a boom of a crane.

FIG. 2 shows a schematic front view of a first embodiment.

FIG. 3 shows a detail view of the detail A shown in FIG. 2.

FIG. 4 shows a top view of rail and slider.

FIG. 5 shows a schematic front view of a second embodiment.

FIG. 6 shows a perspective view of an end boom element.

FIG. 7 shows a detail view of the detail B shown in FIG. 6.

### DETAILED DESCRIPTION

FIG. 1 shows a top view of a boom 10 of a construction machine, such as a crane 8 not shown here in greater detail. The boom 10 is composed of a plurality of lattice boom elements 12, 14, 16 and 18, wherein two middle boom elements 14 and 16 and two boom elements 12 and 18 arranged at each end are provided. The boom elements 12, 14, 16, 18 for example can be connected with each other by means of releasable bolt connections. The boom end element 12 furthermore is the boom element 12 which is attached e.g. to the uppercarriage of the crane.

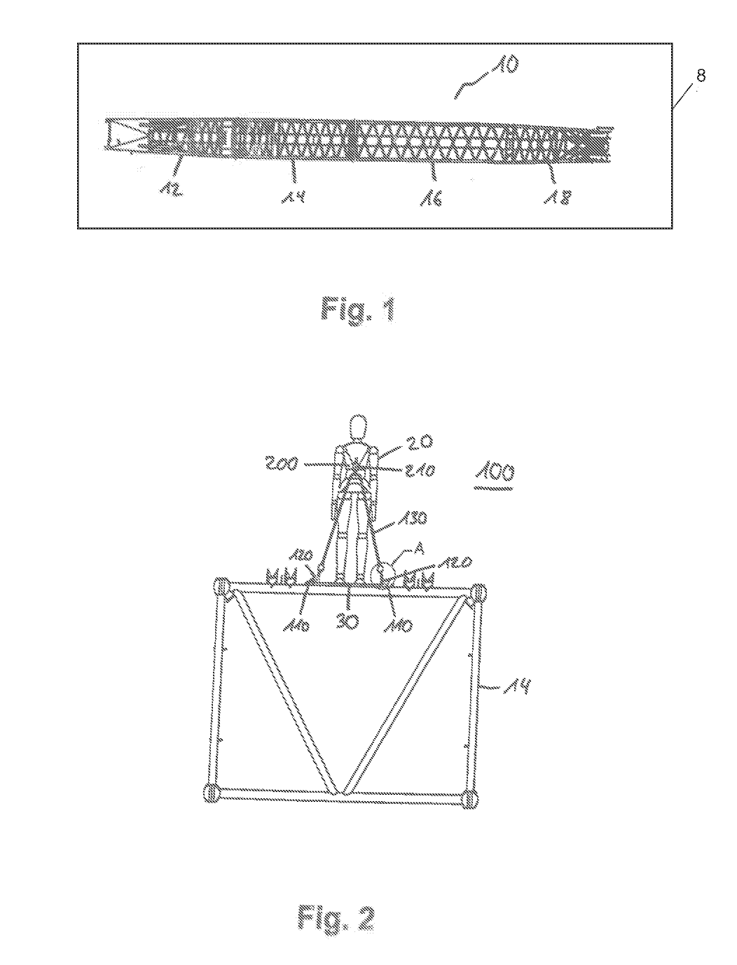

FIG. 2 shows a schematic front view of a first embodiment of the protection system 100. The user 20 is standing e.g. on the boom element 14, which can be inspected by means of a stepping plane 30 designed as step-on grating 30 or other such platform, in one example. On the long sides of the step-on grating 30, fixed guides, such as rails 110 of the protection system 100 each are arranged, on which movable guides, such as sliders 120, are slidingly or otherwise movably mounted.

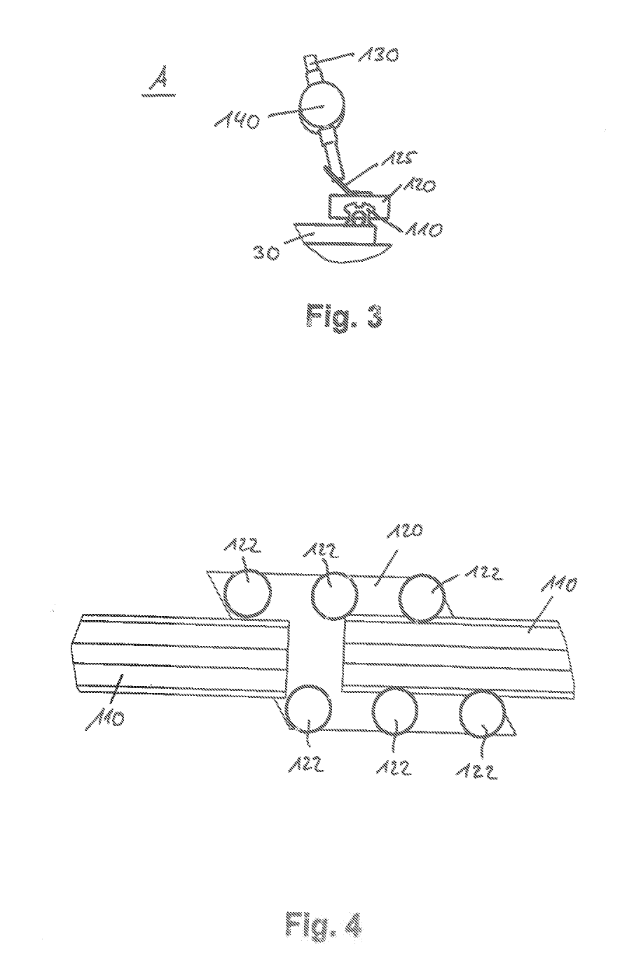

As is shown in FIG. 3 with reference to the detail representation A, the slider 120 encloses the rail 110, in order to prevent a separation of slider 120 and rail 110.

On the upper side of the slider 120 a mounting bracket 125 is provided, to which at suspension device, such as a safety strap 130, is attached. The safety strap 130 is provided with a tightening device, such as strap tensioners 140, each of which is arranged at the ends of the safety strap 130 which are attached to the mounting bracket 125, so that the safety strap 130 can always be kept taut.

By means of the strap tensioners 140 the safety strap 130 is automatically adjusted to the respective body size or also body posture of the user. In this way, the risk of a so-called slack rope, i.e. a safety rope or safety strap hanging down or sagging untensioned, advantageously is prevented, which in the case of a fall would lead to the fact that the fall height would at least be increased, until the safety rope or the safety strap is tightened.

In the embodiment shown in FIG. 2, the safety strap 130 is articulated directly to protective equipment, such as the safety equipment 200 of the user 20. For this purpose, the safety equipment 200 includes a swivel 210 which provides for a free choice of the running direction on the stepping plane 30. The swivel 210 can rotate in a bearing relative to the safety equipment 200, so that re-hanging is not required when changing the running direction.

With regard to the flux of force in the safety strap 130 an advantageous safety strap triangle thus is formed between the three articulation points of the safety strap 130 on the right and left slider 120 as well as the swivel 210.

The safety equipment 200 preferably is designed as a tight-fitting safety corset 200 or as safety vest 200, which in any case is designed to carry the weight of the user 20 in case of a fall.

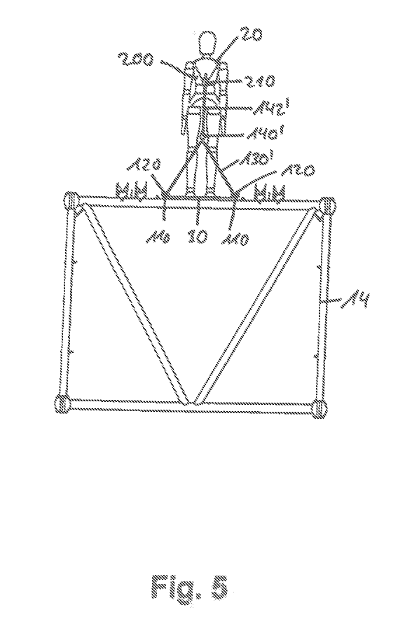

FIG. 4 shows a top view of the bottom side of rail 110 and slider 120. The slider is of rhombic shape and on each long side it each includes three rollers 122 with which the slider 120 is rolling on the rail 110.

FIG. 5 shows another embodiment of the protection system 100 in a schematic front view. This embodiment corresponds to the embodiment shown in FIG. 2 in important features which correspondingly are designated with the same reference numerals.

In contrast to the first embodiment shown in FIG. 2, it is provided here to attach the safety strap 130′ directly to the sliders 120 and centrally provide a strap tensioner 140′. A further connecting strap 142′, which is articulated to the swivel 210, extends from this strap tensioner 140′.

In the embodiment shown in FIG. 5 an advantageous safety strap profile likewise is formed with regard to the flux of force in the safety strap 130, namely a Y-profile between the four articulation points of the safety strap 130′ on the right and left slider 120, the strap tensioner 140′ as well as the swivel 210.

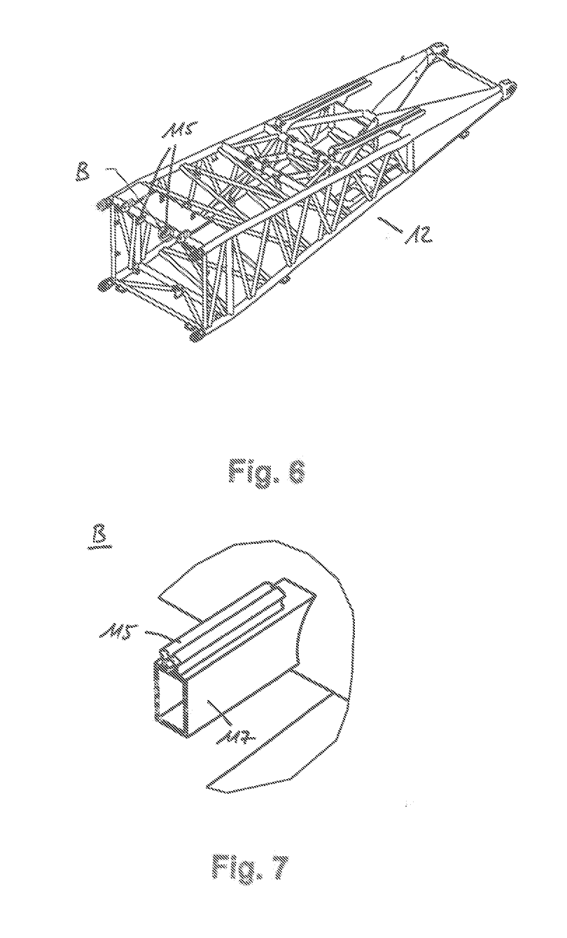

FIG. 6 shows a perspective view of the boom end element 12, on which rail end pieces 115 are provided, which each include a non-illustrated station. On the rail end pieces 115 the slider 120 can be threaded and it can be provided that a non-illustrated lock is used to prevent the slider 120 from moving out of the rail end piece 115. The rails 110 of the next boom element 14 abut against the rail end pieces 115. During non-use, the sliders 120 can be arrested in the stations by an arresting device.

In principle, it can be provided that the rails 110 of the respective boom parts 12, 14, 16, 18 abut against each other, so that a continuous rail 110 is formed over all boom elements. Thus, the entire length of the boom 10 can be inspected, without having to re-hang the safety equipment e.g. on another rail or another safety rope.

FIG. 7 relates to the detail representation of the detail B which is marked correspondingly in FIG. 6. The rail end pieces 115 here are seated on a box-shaped carrier 117. In principle it can be provided that each boom element 12, 14, 16, 18 includes such carrier 117, in order to carry the rail 110.

As rail material, lightweight material preferably can be used; in particular it can be provided that the rails 110 are aluminum rails 110.

1. A safety device for a crane boom comprising at least one guide directly and/or indirectly arranged on a side of a stepping plane and with at least one movable guide which is movably guidable or guided in a sliding manner in the and/or through the guide, wherein a suspension device is attachable or attached to the movable guide, by which at least one protective equipment is suspendable or suspended.

2. The safety device according to claim 1, wherein the suspension device includes at least one tightening device, by which the protective equipment is suspended in a tightened manner.

3. The safety device according to claim 1, wherein the suspension device includes at least one safety strap that is adjustable in its length.

4. The safety device according to claim 1, wherein the guide comprises a rail.

5. The safety device according to claim 1, wherein the guide comprises two parallel guides, and, wherein the suspension device is coupled to both parallel guides.

6. The safety device according to claim 2, wherein the stepping plane includes a stepping platform with long and short sides, wherein at least one movable guide is arranged on each long side of the stepping platform.

7. The safety device according to claim 6, wherein the safety strap is arranged with two articulation points on movable guides and with one articulation point on the protective equipment or an element of the protective equipment, so that the safety strap is stretched out between the at least three articulation points in a triangular or Y-shaped form.

8. The safety device according to claim 7, wherein the protective equipment includes a swivel by which a change in a running direction is performed without re-hanging the protective equipment, and wherein the swivel is at least part of the articulation point for the safety strap.

9. The safety device according to claim 1, coupled to a crane boom, wherein the safety device is structured for the fall protection of persons during inspection of the crane boom, and wherein the guide is fixed to the crane boom.

10. The boom according to claim 9, wherein the boom includes at least one boom end element and at least one boom center element, each of which include at least one rail, wherein in an assembled condition of boom end element and boom center element, the rails are connected to form a common guide rail as the guide and wherein the boom end element includes a rail end, by which the movable guide is blocked from leaving the rail.

11. A construction machine, comprising:
a crane boom,
a safety device structured for the fall protection of persons during inspection of the crane boom, the safety device including at least one guide directly and/or indirectly arranged on a side of a stepping plane and with at least one movable guide which is movably guidable or guided in a sliding manner in the and/or through the guide, wherein a suspension device is attachable or attached to the movable guide, by which at least one protective equipment is suspendable or suspended.

12. The construction machine of claim 11, wherein the suspension device includes at least one tightening device, by which the protective equipment is suspended in a tightened manner, and wherein the suspension device further includes at least one safety strap that is adjustable in its length, wherein the guide comprises two parallel guides fixed on the crane boom, and, wherein the suspension device is coupled to both parallel guides.

13. The construction machine of claim 12, wherein the stepping plane includes a stepping platform with long and short sides, wherein at least one movable guide is arranged on each long side of the stepping platform, and wherein the safety strap is arranged with two articulation points on movable guides and with one articulation point on the protective equipment or an element of the protective equipment, so that the safety strap is stretched out between the at least three articulation points in a triangular or Y-shaped form.

14. The construction machine of claim 13, wherein the protective equipment includes a swivel by which a change in a running direction is performed without re-hanging the protective equipment, and wherein the swivel is at least part of the articulation point for the safety strap.

15. The construction machine of claim 11, wherein the boom includes at least one boom end element and at least one boom center element, each of which including at least one rail, wherein in an assembled condition of boom end element and boom center element, the rails are connected to form a common guide rail as the guide and wherein the boom end element includes a rail end, by which the movable guide is blocked from leaving the rail.

16. A safety device for a crane boom formed of at least a first and second lattice elements, comprising:
a set of parallel guide rails coupled to each of the first and second lattice elements, a first set of rails aligning to form a first common rail and a second set of rails aligning to form a second common rail, when the first and second lattice elements are assembled together to form at least a portion of the crane boom;
a stepping plane positioned between the first and second common rails;
a first and second movable slide, the first slide coupled to the first common rail and the second slide coupled to the second common rail and arranged on each side of the stepping plane;
a suspension device attached to each of the first and second movable slides; and
protective equipment structured to be worn by a person and coupled to the suspension device, wherein the safety device is structured for the fall protection of the persons during inspection of the crane boom and wherein the first and second slides can traverse from guide rails of the first lattice element to guide rails of the second lattice element without re-hanging either the first or second slider to the rails.

17. The safety device of claim 16, wherein the suspension device includes at least one tightening device, by which the protective equipment is suspended in a tightened manner, and wherein the suspension device further includes at least one safety strap that is adjustable in its length, and where abutments of the first and second lattice element are shaped without handholds.

18. The construction machine of claim 17, wherein the stepping plane includes a stepping platform with long and short sides, and wherein the safety strap is arranged with two articulation points on the first and second movable slides, and with one articulation point on the protective equipment or an element of the protective equipment, so that the safety strap is stretched out between the at least three articulation points in a triangular or Y-shaped form.
